(19) United States
(12) Patent Application Publication
(10) Pub. No.: US 2017/0132716 A1
(43) Pub. Date: May 11, 2017

(54) COMPUTER SYSTEM FOR UPDATING TRAVEL AND EXPENSE RECORDS AND OUTPUTTING TRAVEL AND EXPENSE RECOMMENDATIONS

(71) Applicant: CWT Global B.V., Diemen (NL)

(72) Inventors: Hovhannes Khandanyan, Diemen (NL); Carlos Sanchez, Diemen (NL); Catalin Ciobanu, St. Germain en Laye (FR)

(73) Assignee: CWT Global B.V., Diemen (NL)

(21) Appl. No.: 15/280,628

(22) Filed: Sep. 29, 2016

Related U.S. Application Data
(60) Provisional application No. 62/254,077, filed on Nov. 11, 2015.

(51) Int. Cl. G06Q 40/00

(52) U.S. Cl. CPC G06Q 40/12

(57) ABSTRACT

A system for integrating travel and expense data includes a communications interface configured to facilitate receiving travel and expense data in disparate formats and a processing circuit coupled to the communications interface. The processing circuit is configured to receive first travel and expense data in a first format; receive second travel and expense data in a different, second format, the first and second travel and expense data include a plurality of expense transactions; remove erroneous portions of at least one of the first or second travel and expense data; apply a matching algorithm to the first and second travel and expense data to generate a similarity score to identify that the first and second travel and expense data are related; identify each of the plurality of expense transactions of the first and second travel and expense data as trip-related expenses or non-trip-related expenses; and analyze the trip-related expenses and the non-trip-related expenses independent of each other.

### CROSS-REFERENCE TO RELATED PATENT APPLICATIONS

This application claims the benefit of U.S. Provisional Patent Application No. 62/254,077, filed Nov. 11, 2015, which is incorporated herein by reference in its entirety.

### BACKGROUND

In many companies travel and expense spending represents a significant expense: controlling it is crucial to business operations and success. The complexity and sheer volume of travel and expense information makes travel and expense spending challenging to process, manage, and interpret. Traditionally, travel and expense spending analyses present a basic cost breakdown based only on the service bought, overlooking patterns in the employee buying habits.

### SUMMARY

One embodiment relates to a system for integrating travel and expense data. The system includes a communications interface configured to facilitate receiving travel and expense data in disparate formats and a processing circuit coupled to the communications interface. The processing circuit is configured to receive first travel and expense data in a first format; receive second travel and expense data in a different, second format, the first travel and expense data and the second travel and expense data are received from one or more financial systems and include a plurality of expense transactions; remove erroneous portions of at least one of the first travel and expense data or the second travel and expense data; apply a matching algorithm to the first travel and expense data and the second travel and expense data to generate a similarity score to identify that the first travel and expense data and the second travel and expense data are related; identify each of the plurality of expense transactions of the first travel and expense data and the second travel and expense data as trip-related expenses or non-trip-related expenses; and analyze the trip-related expenses and the non-trip-related expenses independent of each other.

Another embodiment relates to a method for integrating travel and expense data. The method includes receiving, by a processing circuit, first travel and expense data in a first format from a first financial system; receiving, by the processing circuit, second travel and expense data in a different, second format from a second financial system, where the first travel and expense data and the second travel and expense data include a plurality of expense transactions; applying, by the processing circuit, a matching algorithm to the first travel and expense data and the second travel and expense data to generate a similarity score to identify that the first travel and expense data and the second travel and expense data are related; identifying, by the processing circuit, each of the plurality of expense transactions of the first travel and expense data and the second travel and expense data as trip-related expenses or non-trip-related expenses; and analyzing, by the processing circuit, the trip-related expenses and the non-trip-related expenses independent of each other.

Still another embodiment relates to a system for integrating travel and expense data. The system includes a communications interface and a processing circuit. The communications interface is configured to receive travel and expense data from one or more financial systems in disparate formats. The travel and expense data includes a plurality of expense transactions. The processing circuit is configured to apply a matching algorithm to the disparate formats of the travel and expense data to generate a similarity score to identify related transactions from the plurality of expense transactions, identify each of the related transactions of the plurality of expense transactions of as trip-related expenses or non-trip-related expenses, and analyze the trip-related expenses and the non-trip-related expenses independent of each other.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram of a travel and expense analysis system, according to an exemplary embodiment.

FIG. 2 is a schematic illustration of a travel and expense decision tree, according to an exemplary embodiment.

FIG. 3 is a schematic illustration of a travel and expense breakdown between trip and non-trip spending, according to an exemplary embodiment.

FIG. 4 is a schematic illustration of non-trip spending broken down into subcategories, according to an exemplary embodiment.

FIG. 5 is a schematic illustration of trip spending broken down into subcategories including air-hotel-car spending and auxiliary spending, according to an exemplary embodiment.

FIG. 6 is a schematic illustration of auxiliary spending broken down into subcategories, according to an exemplary embodiment.

FIG. 7 is a schematic illustration of air-hotel-car spending broken down into subcategories including in-channel spending and off-channel spending, according to an exemplary embodiment.

FIG. 8A is a schematic illustration of in-channel spending broken down into air, hotel, and car subcategories, according to an exemplary embodiment.

FIG. 8B is a schematic illustration of off-channel spending broken down into air, hotel, and car subcategories, according to an exemplary embodiment.

FIGS. 9A-9C are schematic illustrations of in-channel air, hotel, and car spending compared to off-channel air, hotel, and car spending, respectively, according to an exemplary embodiment.

FIG. 10 is a schematic illustration of in-channel spending broken down into subcategories including Travel Management Company (TMC) booked spending and extra spending, according to an exemplary embodiment.

FIG. 11A is a schematic illustration of TMC booked spending broken down into air, hotel, and car subcategories, according to an exemplary embodiment.

FIG. 11B is a schematic illustration of extra spending broken down into air, hotel, and car subcategories, according to an exemplary embodiment.

FIGS. 12A-12C are schematic illustrations of TMC booked air, hotel, and car spending compared to extra air, hotel, and car spending, respectively, according to an exemplary embodiment.

FIG. 13 is a schematic illustration of spending broken down for an individual trip into subcategories including air, hotel, car, and auxiliary spending, according to an exemplary embodiment.

FIG. 14 is a schematic illustration of a graphical user interface for providing outlier analysis data, according to an exemplary embodiment.

FIG. 15 is a schematic illustration of a graphical user interface for providing a comparison of local and non-local spending behavior, according to an exemplary embodiment.

FIG. 16 is a schematic illustration of a graphical user interface for providing T&E spending patterns, according to an exemplary embodiment.

FIG. 17 is a schematic illustration of a graphical user interface of a travel and expense analysis system, according to an exemplary embodiment.

FIG. 18 is a schematic flow diagram of a method for analyzing travel and expense spending, according to an exemplary embodiment.

### DETAILED DESCRIPTION

Following below are more detailed descriptions of various concepts related to, and implementations of, methods, apparatuses, and systems for analyzing travel and expense spending. The various concepts introduced above and discussed in greater detail below may be implemented in any of numerous ways, as the described concepts are not limited to any particular manner of implementation. Examples of specific implementations and applications are provided primarily for illustrative purposes. It should also be understood that the terminology is for the purpose of description only and should not be regarded as limiting.

According to an exemplary embodiment, systems and methods for analyzing travel and expense spending are used to understand spending behaviors of and drivers that lead to employees expensing trip and non-trip expenses, going beyond traditional cost analysis strategies. In many companies, travel and expense (T&E) spending represents a significant expense. The ability to control T&E spending may be influential in business operations and success. T&E data may be used (e.g., by finance, procurement, and/or travel management professionals, etc.) to provide substantial value and facilitate increased control over T&E spending. However, the complexity and sheer volume of T&E data makes it challenging to process, manage, and interpret.

To deal with this complexity, a T&E analysis system may aggregate T&E data into a dynamic framework. The T&E analysis system may then analyze the large amounts of T&E data to define a handful of spending patterns, helping users (e.g., finance, procurement, and/or travel management professionals, etc.) to understand why and how money is being spent, thereby entering employee behavior into the equation, going beyond the capabilities of traditional cost analysis methods. Traditional cost analysis methods take into account the type of service or product purchased and provide a basic T&E analyses based on a cost breakdown by the type of service bought or product purchased.

The T&E analysis system, of the present disclosure, is configured to further incorporate business drivers and employee behaviors during the analysis. As a brief overview, the T&E analysis system is configured to analyze each expense of T&E spending based on (i) the type of service or product bought, (ii) the spending behavior of the employee, and (iii) the business driver (e.g., context, etc.) requiring the expense. Therefore, the T&E analysis system is configured to provide users with the ability to focus on employees' compliance with spending policies (e.g., of the employer, company, organization, etc.). The T&E analysis system may be further configured to provide intuitive results that may facilitate pinpointing areas of a company's T&E spending that may require specific attention and/or action. Therefore, the T&E analysis system may help users to optimize spending and contribute to enhanced security, policy compliance, and employee (e.g., a traveling employee's, etc.) experience.

According to an exemplary embodiment, the T&E analysis system provides an improved understanding and facilitate optimizing T&E spending by first sorting expenses into categories using a decision tree framework. The decision tree is configured to establish whether an expense was (i) made while travelling or not, (ii) associated with a regular travel supplier (e.g., air, hotel, car, etc.) or not, (iii) was made via a travel management company (TMC) or not, and/or (iv) was different from the TMC amount recorded at booking time. The categories may include trip and non-trip expenses. The trip expenses may be further broken into auxiliary expenses, in-channel expenses: travel management company (TMC) booked expenses and extra expenses, and/or off-channel expenses, among other possible categories. The T&E analysis system may be further configured to break each of the categories down further into a set of subcategories (e.g., air, hotel, car, meals, etc.). Emerging spending patterns may then be investigated to identify specific areas for optimization. The first step allows an immediate high-level view of T&E spending, while the second step takes a closer look into the actions needed for improving spending. These actions may include adjusting the business drivers (e.g., modifying the amount of travel or expenses, etc.), improving employee purchasing behavior and policy compliance, as well as negotiating new partnerships with suppliers.

The decision tree used by the T&E analysis system facilitates understanding why and how money is being spent by employees, which in turn helps identify the areas of spending where action is most needed in order to mitigate costs and improve employees' compliance and travel experience. The T&E analysis system provides benefits including a strategic perspective, simplicity, and flexibility, among other benefits. The strategic perspective includes providing a single view over a plurality of categories of T&E spending (e.g., non-trip expenses, trip expenses, etc.). These categories are defined to reflect and incorporate the demand for travel as well as the travelers' behavior. The simplicity includes providing a numerical and visual output which is easy to understand and interpret. The flexibility includes integrating new subcategories and algorithms which may be used to understand certain aspects of T&E spending. For example, new categories may be defined by booking channel used (e.g., online versus agent-booked, etc.) and/or the form of payment used by the employee (e.g., corporate credit card, personal credit card, etc.). The T&E analysis system may also facilitate studying all of the expense categories simultaneously (e.g., rather than in isolation as in traditional T&E analysis, etc.) and from the very beginning of the T&E data analysis. This allows companies to pinpoint and prioritize the main strategic areas for optimization.

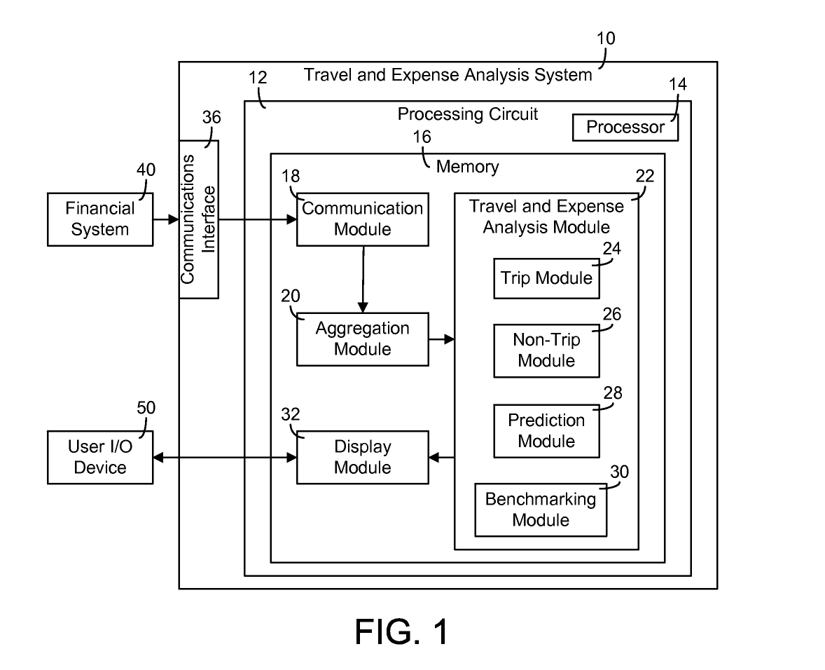

Referring now to FIG. 1, FIG. 1 shows a schematic diagram of an analysis system, shown as travel and expense (T&E) analysis system 10. The T&E analysis system 10 is configured to provide a user with the ability to have increased control over and optimization of T&E spending.

As shown in FIG. 1, the T&E analysis system 10 includes a communication interface 36 and a processing circuit 12. The communication interface 36 may be configured to facilitate the communication between the T&E analysis system 10 and a financial system 40 and/or a user input/output (I/O) device 50. The communication may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, Bluetooth, Zigbee, etc. In one embodiment, a controller area network (CAN) bus provides the exchange of signals, information, and/or data. The CAN bus includes any number of wired and wireless connections.

The user I/O device 50 may include a display screen, a touch screen, one or more buttons, a touch pad, a mouse, and/or other devices to allow a user to operate and/or communicate with the T&E analysis system 10. In some embodiments, the user I/O device 50 is or includes a portable device. The portable device may include, but is not limited to, a smartphone, a tablet, a laptop, a smart watch, and/or any other type of form factor device. In some embodiments, the user I/O device 50 is or includes a stationary device (e.g., a desktop computer, etc.). According to an exemplary embodiment, the user I/O device 50 is configured to provide a display (e.g., a graphical user interface, etc.) to the user of the T&E analysis system 10. The user I/O device 50 may display processed and/or analyzed T&E data acquired by the T&E analysis system 10 from the financial system 40. In some embodiments, the user I/O device 50 allows a user to enter trip parameters for a future trip (e.g., to receive a projected trip cost from the T&E analysis system 10, etc.) and/or select a desired graphical user interface to inspect certain portions of the analyzed T&E data (e.g., to determine areas for improvement or optimization, etc.).

The financial system 40 may be or include a system that is configured to receive and store T&E data (e.g., transaction information, etc.) indicative of T&E spending (e.g., for an employee, for a company, etc.). The T&E data may also include information regarding the original price of bookings (e.g., to compare originally booked prices to the actual amount expensed to determine the cost of incidentals for the booking when a non-itemized bill is expensed, etc.). According to an exemplary embodiment, the financial system 40 includes at least one of an expense reporting system, a financial accounting system, and a credit card system (e.g., including personal credit card statements, corporate credit card statements, etc.). The financial system 40 may be configured to provide the T&E data and/or any other pertinent information about T&E spending to the T&E analysis system 10.

As shown in FIG. 1, the processing circuit 12 includes a processor 14 and a memory 16. The processor 14 may be implemented as a general-purpose processor, an application specific integrated circuit (ASIC), one or more field programmable gate arrays (FPGAs), a digital signal processor (DSP), a group of processing components, or other suitable electronic processing components. The memory 16 (e.g., RAM, ROM, Flash Memory, hard disk storage, etc.) may store data and/or computer code for facilitating the various processes described herein. Thus, the memory 16 may be communicably connected to the processor 14 and provide computer code or instructions to the processor 14 for executing the processes described in regard to the T&E analysis system 10 herein. Moreover, the memory 16 may be or include tangible, non-transient volatile memory or non-volatile memory. In some embodiments, the memory 16 may include database components, object code components, script components, or any other type of information structure for supporting the various activities and information structures described herein.

The memory 16 is shown to include various modules for completing processes described herein. More particularly, the memory 16 includes a communication module 18, an aggregation module 20, a T&E analysis module 22, and a display module 32 configured to interpret and provide T&E data to a user of the T&E analysis system 10. While various modules with particular functionality are shown in FIG. 1, it will be understood that the T&E analysis system 10 and the memory 16 may include any number of modules for completing the functions described herein. For example, the activities of multiple modules may be combined as a single module and additional modules with additional functionality may be included. Further, it will be understood that the processing circuit 12 of the T&E analysis system 10 may further control other processes beyond the scope of the present disclosure.

The communication module 18 may be communicably and/or operatively coupled to the communication interface 36 and configured to control the communication (e.g., the transfer of information, T&E data, etc.) between the T&E analysis system 10 and the financial system 40. As such, the communication module 18 may include communication circuitry (e.g., relays, wiring, network interfaces, circuits, etc.) that facilitate the exchange of information, data, values, non-transient signals, etc. between and among the communication module 18, communications interface 36, and/or the financial system 40. In some embodiments, the communication module 18 is or includes the communications interface 36. According to an exemplary embodiment, the communication module 18 is configured to store a plurality of protocols that facilitate receiving T&E data is various disparate (e.g., different, non-uniform, etc.) formats (e.g., .txt files, .xls files, .docx files, .pdf files, .zip files, .jpg files, comma separated value (CSV) files, a custom API that uses a custom format, etc.).

The aggregation module 20 may be configured to aggregate (e.g., gather, compile, etc.) the T&E data from the financial system 40 (e.g., for each employee of a company, etc.) via the communication module 18 and/or communication interface 36. As such, the aggregation module 20 may include communication circuitry (e.g., relays, wiring, network interfaces, circuits, etc.) that facilitate the exchange of information, data, values, non-transient signals, etc. between and among the aggregation module 20, the communication module 18, the communications interface 36, and/or the financial system 40. In some embodiments, the aggregation module 20 periodically receives T&E data from the financial system (e.g., end of day, based on a schedule, etc.). In some embodiments, the aggregation module 20 is or includes the financial system 40 such that T&E data is directly uploaded to the aggregation module 20 after a qualifying T&E expense is made by an employee (e.g., in real-time, etc.). In some embodiments, the aggregation module 20 is configured to store the T&E data (e.g., for use by other modules, etc.).

The aggregation module 20 may receive the T&E data in two or more disparate formats from the financial systems 40 (e.g., the expense reporting system, the financial accounting system, the credit card system, etc.). The aggregation module 20 may be configured to perform data cleansing, data recovering, and/or data quality checking to combine (e.g., bundle, join, etc.) the disparate data based on employee, trip, etc. into a uniform or consistent format that is able to be more accurately and readily analyzed by the T&E analysis module 22. The data cleansing may include removing erroneous portions of the data that may not be used by the T&E analysis module 22 and/or scrubbing the data to separate the useful portions from the erroneous portions. The non-erroneous portions may also be modified (e.g., altered, fixed, corrected, restored, standardized, etc.) to provide the T&E data in a desired, uniform format. The data recovering may include restoring some of the missing data field values in an algorithmic approach based on other data field values available in the non-erroneous portion of the data. The Data quality check may include scanning through individual data fields and validating recorded data values (e.g., there cannot be more than 31 days in a month, transaction dates that extend into the future, names that contain only one letter, etc.).

Combining the disparate data may include implementing an approximate matching algorithm to compare the cleansed, scrubbed, and/or modified data from the different data streams (i.e., disparate formats). The approximate matching algorithm may be configured to cross-correlate the data from the different data streams to make matches (e.g., of transactions associated with a single employee, a single trip, etc.). By way of example, the aggregation module 20 may be configured to develop a similarity score between two or more data entries. The similarity score may be based on (i) a comparison of various data fields within the data entries and (ii) various weights associated with each of the respective data fields (e.g., a more precise data field such as a hotel transaction identification number may be given a greater weight than a hotel name, etc.). The similarity score may range from 0% (e.g., unrelated entries, dissimilar, etc.) to 100% (e.g., related, similar, etc.). According to an exemplary embodiment, the aggregation module 20 is configured to determine that disparate data relates to the same employee and/or trip in response to the similarity score for the disparate data being greater than a threshold value (e.g., 70%, 80%, etc.). The similarity score may also take into account synonyms, nicknames, abbreviations, alternate spellings, typographical errors, common spelling mistakes, etc. when matching the disparate data.

The T&E analysis module 22 may be configured to interpret the T&E data aggregated by the aggregation module 20 (e.g., the cleansed and matched data, etc.) and provide the interpreted T&E data to the display module 32 for display to a user via the user I/O device 50. As such, the T&E analysis module 22 may include communication circuitry (e.g., relays, wiring, network interfaces, circuits, etc.) that facilitate the exchange of information, data, values, non-transient signals, etc. between and among the T&E analysis module 22, the aggregation module 20, and/or the display module 32. As shown in FIG. 1, the T&E analysis module 22 includes a trip module 24, a non-trip module 26, a prediction module 28, and a benchmarking module 30.

Referring to FIGS. 1-3, the T&E analysis module 22 is configured to analyze the aggregated T&E data using a decision tree framework 100 to categorize each expense (e.g., a trip expense, a non-trip expense, etc.) to break down T&E spending into categories that reflect travel and traveler's behavior. The trip module 24 is configured to interpret the T&E data to determine which expenses from the T&E spending relate to trip expenses (e.g., expenses incurred from an employee on a business trip, etc.), shown as trip-related expenses 110. The trip module 24 may be further configured to analyze and separate the trip-related expenses 110 further into subcategories. The non-trip module 26 is configured to interpret the T&E data to determine which expenses from the T&E spending relate to non-trip expenses (e.g., expenses incurred from an employee not on a business trip, expenses incurred relatively locally, etc.), shown as non-trip-related expenses 180.

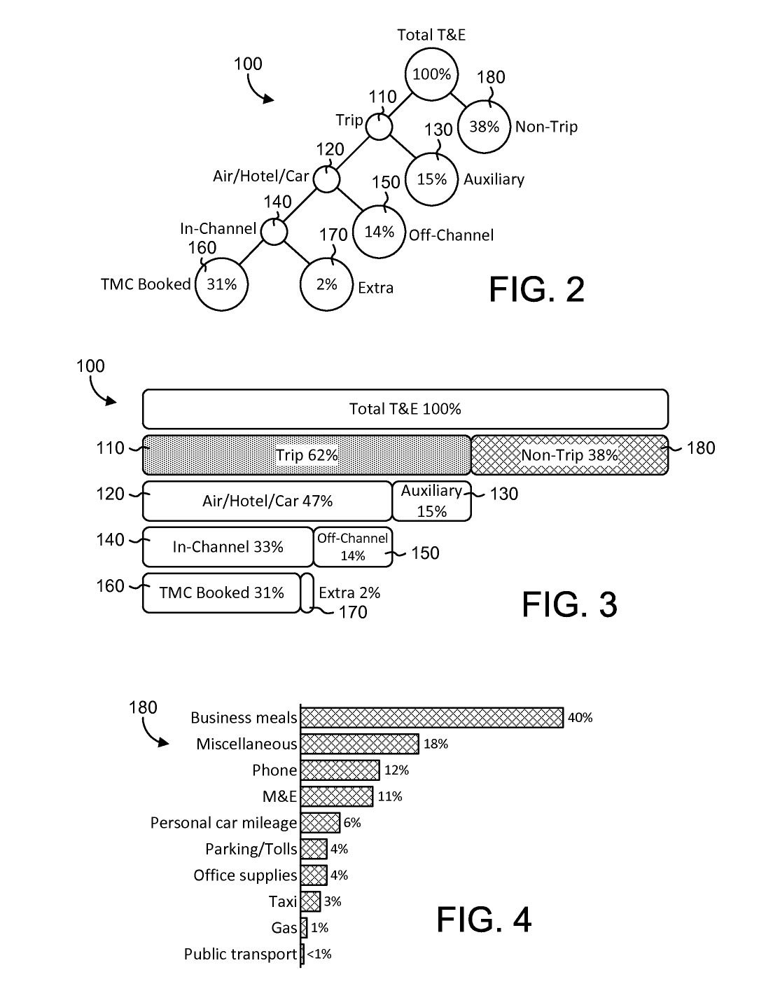

As shown in FIGS. 2-3, the subcategories of the trip-related expenses 110 include air, hotel, and car expenses 120 and auxiliary expenses 130. The air, hotel, and car expenses 120 may be further broken up (e.g., divided, segregated, separated, sorted, etc.) into in-channel air, hotel, and car expenses, shown as in-channel expenses 140, and off-channel air, hotel, and car expenses, shown as off-channel expenses 150. The in-channel expenses 140 may be further broken up into travel management company booked in-channel expenses, shown as TMC booked expenses 160, and extra in-channel expenses, shown as extra expenses 170.

According to an exemplary embodiment, the trip module 24 and the non-trip module 26 are configured to separate the T&E data into five main categories including the auxiliary expenses 130, the off-channel expenses 150, the TMC booked expenses 160, the extra expenses 170, and the non-trip-related expenses 180. Categorizing T&E spending into smaller subcategories may facilitate understanding employee behavior and drivers behind employee spending, as well as identifying specific area of T&E spending that may need to be further analyzed and/or optimized.

The auxiliary expenses 130 may relate to expenses that occur prior to and/or during a trip (e.g., a business trip, company retreat, etc.) that are not booked through a TMC and do not relate to any of an airline, a hotel, and a car rental company. The off-channel expenses 150 may relate to expenses that occur prior to and/or during a trip relating to services that were not booked via a TMC. The off-channel expenses 150 may include and/or relate to at least one of airline expenses (e.g., purchase of a plane ticket, etc.), hotel expenses (e.g., a room reservation, non-incidental expenses, etc.), and a car rental company (e.g., a rental car reservation, etc.). For example, the off-channel expenses 150 include airline, hotel, and/or car rental reservations made by an employee or an employee's assistant directly. The TMC booked expenses 160 may relate to expenses that occur prior to and/or during a trip for services that were booked via a TMC (e.g., a travel agent, etc.). The TMC booked expenses 160 may include and/or relate to at least one of airline expenses (e.g., purchase of a plane ticket, etc.), hotel expenses (e.g., a room reservation, non-incidentals, etc.), and a car rental expenses (e.g., a rental car reservation, etc.). The extra expenses 170 may relate to expenses that are subsequently added to a TMC booked service by the traveler (e.g., employee, etc.). The non-trip-related expenses 180 may include and/or relate to expenses incurred by an employee while not on a trip (e.g., local expenses, office expenses, non-traveling expenses, etc.).

According to an exemplary embodiment, determining the portion of spending associated with traveling and non-traveling is the first step in understanding T&E spending. For example, certain companies may have a client base that is mostly local (e.g., such as in larger cities, etc.) such that most T&E spending includes non-trip-related expenses 180, while other companies may have a dispersed client base such that employees may travel relatively further to maintain team and client relationships, such that the company incurs a greater amount of trip-related expenses 110. Analyzing the amount of trip-related expenses 110 relative to the non-trip-related expenses 180 may provide an indication of the alignment of T&E spending with the business objectives of a company. For example, the total T&E spending split between trip-related expenses 110 and non-trip-related expenses 180 should reflect corporate priorities. By way of example, global business expansion may be accompanied by a higher proportion of trip-related expenses 110. Conversely, a travel “freeze” should result in a higher proportion of non-trip-related expenses 180.

According to an exemplary embodiment, the T&E analysis module 22 is configured to form transaction blocks for expenses that have the same trip or expense identifier (e.g., where applicable, etc.), have similar date ranges, and/or have at least one similar employee involved. The transaction blocks that includes at least one expense related to air travel, lodging, and/or rental car transactions are identified as trip blocks and are then further analyzed by the trip module 24. All other transaction blocks that are not identified as a trip block (e.g., non-trip blocks, etc.) by the T&E analysis module 22 are then further analyzed by the non-trip module 26.

Referring to FIGS. 1 and 3-4, the non-trip module 26 may be configured to analyze and separate the non-trip-related expenses 180 further into subcategories. As described above, the non-trip-related expenses 180 include expenses that are incurred while not traveling (e.g., local expenses, etc.). As shown in FIG. 4, the non-trip-related expenses 180 include expenses relating to (i) business meals (e.g., taking a client out to lunch, etc.), (ii) phone plans (e.g., a company paid cell phone plan, etc.), (iii) meetings and/or events (e.g., training, a golf event, recruiting events, conferences, etc.), (iv) transportation including personal car mileage, gas, parking, and/or tolls, taxi or limousine services, and/or public transposition (e.g., for an employee to drive or get to a local client, etc.), (v) office supplies, and/or other non-trip expenses.

A user of the T&E analysis system 10 may scrutinize the non-trip-related expenses 180 broken down into subcategories by analyzing the relative contributions of each subcategory. For instance, if business meal spending is sizable, then one may envision new partnerships with local restaurants or catering service providers. Further reduction of the non-trip-related expenses 180 may result from analyzing the distributions paid within each subcategory and isolating any outliers (e.g., the expenses which are significantly higher than the average, etc.). Recurring high-spending behavior may also be flagged and discussed with the employee(s) of concern to mitigate future high spending.

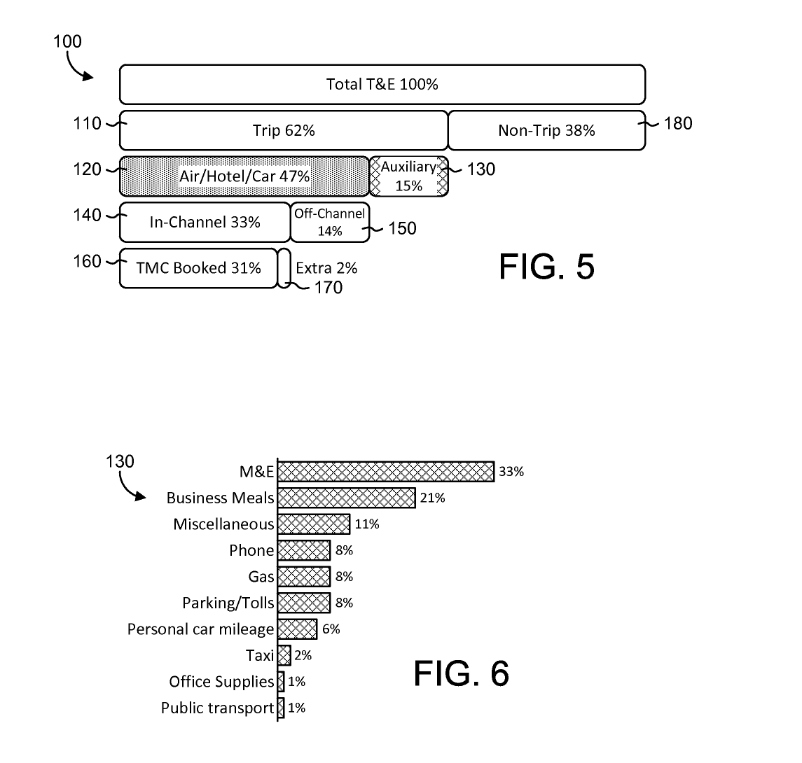

Referring to FIGS. 1 and 5-6, the trip module 24 may be configured to analyze and separate the trip-related expenses 110 into the air, hotel, and car expenses 120 and the auxiliary expenses 130. As described above, the auxiliary expenses 130 may relate to expenses that occur prior to and/or during a trip (e.g., a business trip, company retreat, etc.) that are not booked through a TMC and do not relate to any of an airline, a hotel, and a car rental company. In some instances, the auxiliary expenses 130 may account for a substantial portion of a company's trip-related expenses 110 (e.g., depending on at least one of the company and/or company culture, the length of stay, and traveler behavior, etc.). As shown in FIG. 6, the auxiliary expenses 130 include expenses relating to (i) business meals (e.g., eating breakfast, lunch, and/or dinner at a restaurant, etc.), (ii) phone (e.g., international calling charges, etc.), (iii) meetings and/or events (e.g., training, a golf event, recruiting events, conferences, etc.), (iv) transportation including personal car mileage, gas, parking, and/or tolls, taxi or limousine services, and/or public transposition (e.g., for an employee to get from the airport to the hotel, etc.), and/or other trip expenses not relating to at least one of an airline, a hotel, and a car rental company. Analyzing patterns in the subcategories of the auxiliary expenses 130 (e.g., over time, on an employee by employee basis, etc.) may facilitate optimizing auxiliary spending (e.g., recognizing outliers, etc.).

A user of the T&E analysis system 10 may gain deeper insights into the total cost of a trip by knowing the relative importance of the different subcategories of the auxiliary expenses 130. As with the non-trip-related expenses 180 discussed above, actions to lower auxiliary expenses 130 may include negotiating supplier partnerships and/or modifying traveler behavior when outliers and/or recurring high-spend patterns are identified, among other possible actions.

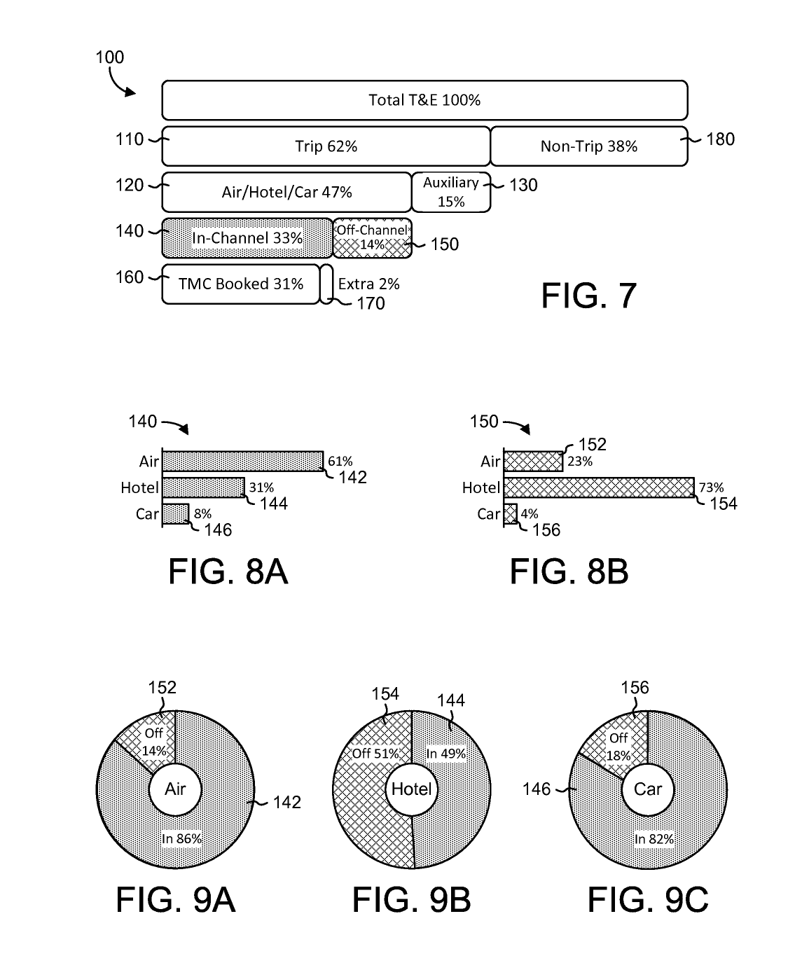

Referring to FIGS. 1 and 7-9C, the trip module 24 may be configured to analyze and separate the air, hotel, and car expenses 120 into in-channel expenses 140 and off-channel expenses 150. The in-channel expenses 140 may relate to expenses that occur prior to and/or during a trip relating to services that were booked via a TMC and/or relate to at least one of an airline, a hotel, and a car rental company. For example, the in-channel expenses 140 may include airline, hotel, and/or car rental reservations made by a TMC and any additional expenses relating to airline, hotel, and/or car rental reservations. The off-channel expenses 150 may relate to expenses that occur prior to and/or during a trip relating to services that were not booked via a TMC (e.g., directly booked by the traveler, etc.), but relate to at least one of an airline, a hotel, and a car rental company. For example, the off-channel expenses 150 may include airline, hotel, and/or car rental reservations not made by a TMC (e.g., booked directly by the traveler, etc.) and/or any additional expenses relating to airline, hotel, and/or car rental reservations.

According to the exemplary embodiment shown in FIGS. 8A-8B, the trip module 24 may be configured to sub-categorize the in-channel expenses 140 and/or the off-channel expenses 150 into airline related expenses, shown as in-channel airline expenses 142 and off-channel airline expenses 152, hotel related expenses, shown as in-channel hotel expenses 144 and off-channel hotel expenses 154, and car rental related expenses, shown as in-channel car rental expenses 146 and off-channel car rental expenses 156, respectively. The in-channel airline expenses 142 and/or the off-channel airline expenses 152 may include expenses such as an airline ticket, luggage surcharges, in-flight purchases, seating upgrades, and the like. The in-channel hotel expenses 144 and/or the off-channel hotel expenses 154 may include expenses such as a room reservation, room service, laundry services, pay-per-view, room upgrades, and/or other charges (e.g., incidentals, etc.) that may be applied and/or relate to the hotel reservation. The in-channel car rental expenses 146 and/or the off-channel car rental expenses 156 may include expenses such as a car rental, rental insurance, fuel costs, mileage surcharges, tolls, navigation services, and/or other charges that may be applied and/or relate to the car rental.

According to the exemplary embodiment shown in FIGS. 9A-9C, the trip module 24 may be configured to compare the in-channel airline expenses 142 and the off-channel airline expenses 152, the in-channel hotel expenses 144 and the off-channel hotel expenses 154, and/or the in-channel car rental expenses 146 and the off-channel car rental expenses 156. This may provide indications to which subcategories of the in-channel expenses 140 and the off-channel expenses 150 are predominately TMC booked or independently booked.

As discussed above, the off-channel expenses 150 may be broken down into air, hotel and car subcategories and further analyzed to understand which suppliers tend to get the highest share of off-channel bookings (e.g., low cost carriers, sharing economy providers, etc.).

According to an exemplary embodiment, users of the T&E analysis system 10 may use the subcategories to take actions to improve compliance including negotiating new supplier partnerships and correcting recurring off-channel booking behavior for both travelers and travel approvers. Also, the off-channel expenses 150 may be analyzed to understand when and why travelers are opting to book directly with air, hotel, and/or car suppliers rather than via a TMC. Other analyses may focus on the emergence of peer-to-peer accommodation and/or ride-sharing services.

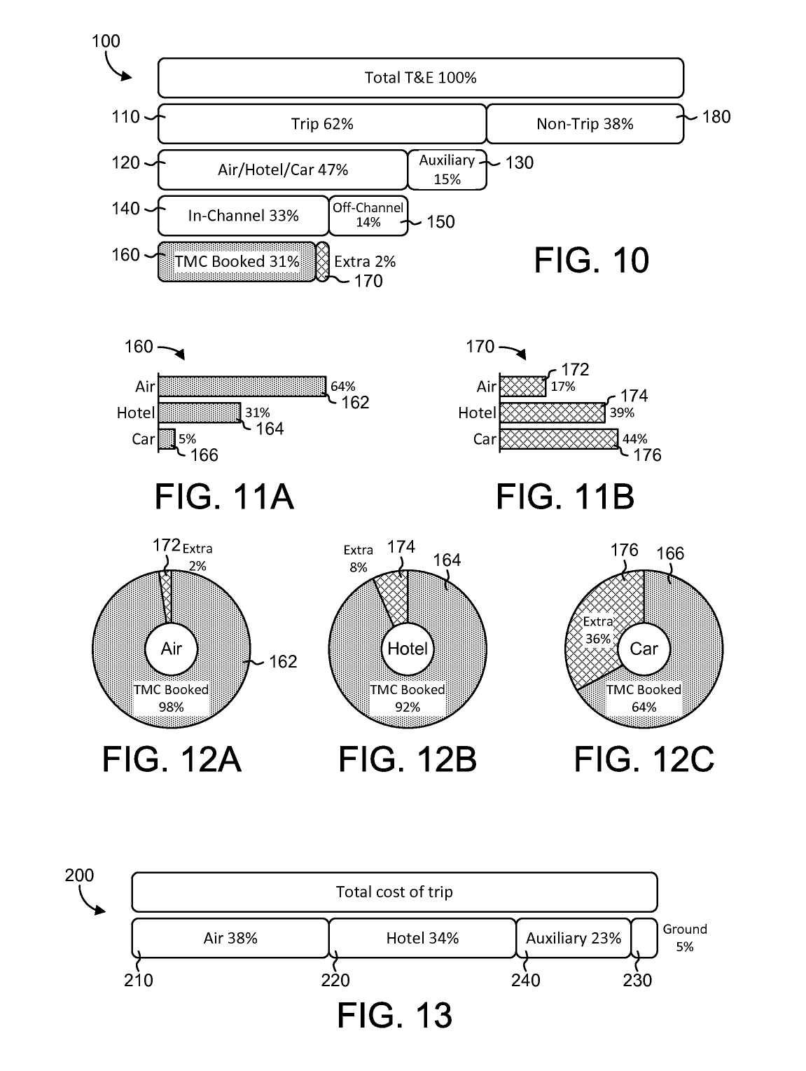

Referring to FIGS. 1 and 10-12C, the trip module 24 may be configured to analyze and separate the in-channel expenses 140 into TMC booked expenses 160 and extra expenses 170. For example, the in-channel expenses 140 may include airline, hotel, and/or car rental reservations made by a TMC and any additional expenses relating to airline, hotel, and/or car rental reservations, while the TMC booked expenses 160 include the in-channel expenses 140 that were directly booked by the TMC and the extra expenses 170 include the additional expenses that were not included in the original reservation booked by the TMC (e.g., add-ons, incidentals, upgrades, etc.).

According to an exemplary embodiment, the extra expenses 170 includes two main contributions: (i) ancillary expenses and (ii) non-itemized expenses. Ancillary expenses may be encountered in association with the TMC booked expenses 160. Examples of ancillary expenses include baggage fees or extra legroom for air travel; room upgrade or pay-per-view for lodging; and insurance and GPS navigation for rental cars. Taxes and fees are other indispensable parts of the extra expenses to be included in the total cost analysis. Non-itemized expenses may be encountered when a single receipt for a combination of services is issued. For example, a traveler (e.g., an employee, etc.) may receive a single, non-itemized bill for a hotel stay, laundry services, and in-room dining. Consequently, auxiliary services (e.g., laundry services and in-room dining, etc.) may not be itemized in the expense report for the trip. Therefore, the trip module 24 may be configured to compare the original amount of a TMC booking (e.g., a hotel reservation, etc.) to the final expensed amount to determine the non-itemized, auxiliary expenses (e.g., the extra expenses 170 that were not itemized, etc.) for the in-channel expenses 140.

According to the exemplary embodiment shown in FIGS. 11A-11B, the trip module 24 may be configured to sub-categorize the TMC booked expenses 160 and/or the extra expenses 170 into airline related expenses, shown as TMC booked airline expenses 162 and extra airline expenses 172, hotel related expenses, shown as TMC booked hotel expenses 164 and extra hotel expenses 174, and car rental related expenses, shown as TMC booked car rental expenses 166 and extra car rental expenses 176, respectively. The TMC booked airline expenses 162 may include expenses such as an airline ticket, while the extra airline expenses 172 may include expenses such as luggage surcharges, in-flight purchases (e.g., snacks, beverages, interne accessibility, television, etc.), seating upgrades, and/or other charges that may be applied and/or relate to the airline reservation. The TMC booked hotel expenses 164 may include expenses such as a room reservation, while the extra hotel expenses 174 may include expenses such as room service, laundry services, pay-per-view, room upgrades, and/or other charges (e.g., incidentals, etc.) that may be applied and/or relate to the hotel reservation. The TMC booked car rental expenses 166 may include expenses such as a car rental, while the extra car rental expenses 176 may include expenses such as rental insurance, fuel costs, mileage surcharges, tolls, navigation services, and/or other charges that may be applied and/or relate to the car rental.

According to the exemplary embodiment shown in FIGS. 12A-12C, the trip module 24 may be configured to compare the TMC booked airline expenses 162 and the extra airline expenses 172, the TMC booked hotel expenses 164 and the extra hotel expenses 174, and/or the TMC booked car rental expenses 166 and the extra car rental expenses 176. This may provide indications to which subcategories of the TMC booked expenses 160 and the extra expenses 170 frequently experience incidental or extra spending from employees.

As discussed above, the extra expenses 170 may be broken down into air, hotel, and car subcategories. According to an exemplary embodiment, users of the T&E analysis system 10 may use the subcategories to take actions to lower these costs. For example, a user may analyze the subcategories and determine which ancillary services employees frequently add onto a TMC booked service (e.g., such as GPS navigation and insurance for a car rental, onboard Wi-Fi, etc.). Therefore, a company may negotiate pricing with suppliers for the popular ancillary services to be included in the initial booking price. As another example, a user may use the data to monitor if employees are paying for services which have already been included in the negotiated rate (e.g., being double charged, etc.).

Referring to FIGS. 1 and 13, the projection module 28 may be configured to analyze the T&E data to project (e.g., estimate, predict, etc.) the total cost of a trip 200, based on probable air expenses 210, hotel expenses 220, ground expenses 230, and/or auxiliary expenses 240. For example, a user may input various parameters of a future trip. The trip parameters may include an origin city, a destination city, a number of nights, advance booking days (e.g., the difference between the current date and the departure date, etc.), and/or other trip parameters. The projection module 28 may analyze the T&E data to find similar trips matching the trip parameters. For example, the projection module 28 may search for trips that included the same origin and destination cities. As another example, the projection module 28 may search for trips that were taken around the same time (e.g., date, etc.) that the future trip is scheduled for. The projection module 28 may be configured to project the cost of the future trip based on similar trips found within the T&E data.

In some embodiments, the projection module 28 provides multiple projections, taking into account different hotels, airports, and/or car rental companies other travelers have used for a similar trip. Travelers and travel approvers may use the projections (e.g., benchmarks, etc.) in deciding whether to take the trip or to approve the trip request, respectively. In another example, the projection module 28 may incorporate an expected return (e.g., return on investment, etc.) for the trip and perform a cost-benefit analysis to determine whether the trip should be approved, declined, or have alternate travel booked. In yet another example, the projection module 28 may be configured to estimate the costs involved in moving employees from point A to point B (e.g., relocation, etc.).

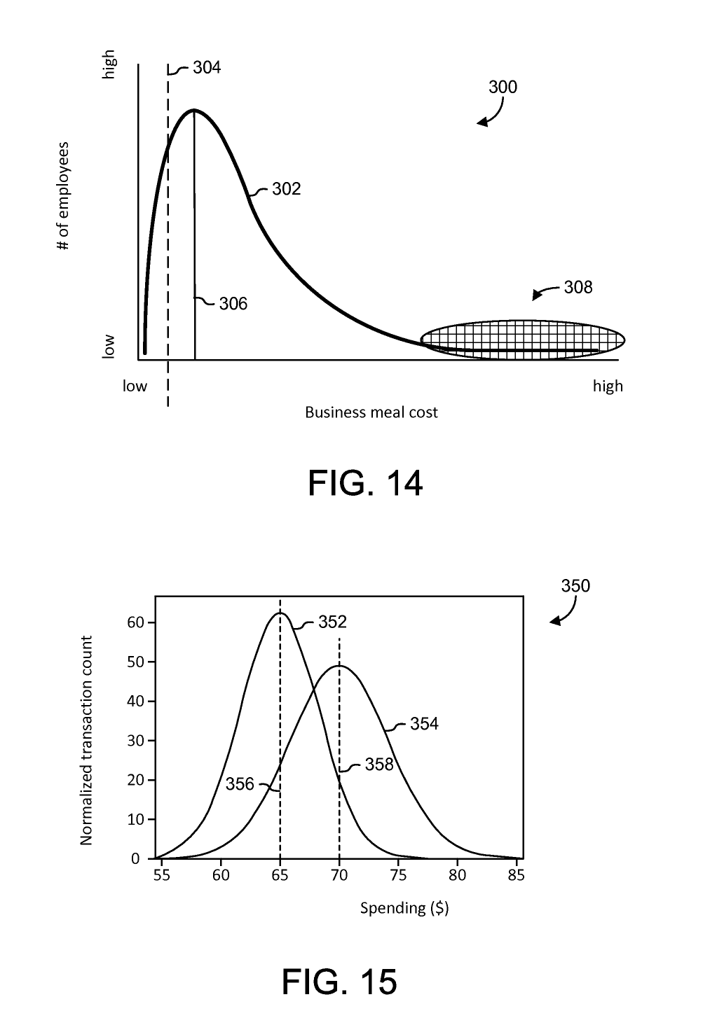

Referring to FIGS. 1 and 14, the benchmarking module 30 may be configured to analyze the T&E data to benchmark the total cost of a trip (or other expenses) with similar trips (or similar expenses). For example, a user may input various parameters of an expensed trip or select an expensed trip. The trip parameters may include an origin city, a destination city, a number of nights, advance booking days (e.g., the difference between the current date and the departure date, etc.), a total amount expensed, and/or other trip parameters. The benchmarking module 30 may analyze the T&E data to find similar trips matching the trip parameters. For example, the benchmarking module 30 may search for trips that included the same origin and destination cities. As another example, the benchmarking module 30 may search for trips that were taken around the same time (e.g., date, etc.) that the expensed trip took place. The benchmarking module 30 may be configured to determine a quality of the trip based on similar trips found within the T&E data. For example, the benchmarking module 30 may provide an indication of a cost effectiveness of the expensed trip relative to similar trips or trips on the same route (e.g., the expensed trip ranks in the top X % in total cost, etc.). This may be used to identify routes or travelers with high spending patterns and therefore, a user (e.g., a company, etc.) may negotiate deals with suppliers or adjust traveler behavior.

As shown in FIG. 14, the benchmarking module 30 may be configured to compare any expenses (or complete trips) included within the T&E data. As shown in FIG. 14, a benchmarking analysis graph 300 includes a spending distribution curve 302 for employees of a company. The benchmarking analysis graph 300 also includes a desired benchmark 304 and a current expense indicator 306. The current expense indicator 306 may indicate where a current expense lies in relation to similar expenses. The benchmarking module 30 may also be configured to identify outliers based on the T&E data, as indicated by outlier section 308 of the benchmarking analysis graph 300. From the benchmarking analysis graph 300, a user of the T&E analysis system 10 may identify a quality of a current expense to other similar expenses. For example, lunch expenses may be compared to other lunch expenses, expenses for a certain party size may be compared to similar party sizes, etc. The user of the T&E analysis system 10 may also use the benchmarking analysis graph to identify outliers and educate employees how to avoid this behavior in the future.

Referring to FIGS. 1 and 15, the benchmarking module 30 may be configured to analyze the T&E data to compare the buying behavior of local employees to visiting employees. For example, a user may compare expenses between local and non-local employees for similar types or categories. The benchmarking module 30 may analyze the T&E data to identify differences between the two. For example, the benchmarking module 30 may reveal differences in the buying behavior of travelling and non-traveling employees in a respective city. Such a comparison may be used to determine whether visiting employees may learn best practices from the local employees. By way of example, lunch expenses maybe compared between employees that are local in a given city to employees that travel to the given city for business. Further, a user may identify restaurants popular among local employees and educate himself or herself about those restaurants. Another example may be cost of urban mobility which includes costs for taxi, public transport, personal mileage, and rental car. Comparing the mobility suppliers popular by local employees and visitors may reveal good practices that visitors may subsequently be able to assume from local employees. Such an analysis may allow visiting employees to receive better quality for a lower price, as well as increase the enjoyment of such travel.

As shown in FIG. 15, the benchmarking module 30 may be configured to compare similar expenses for local and non-local employees within the T&E data. As shown in FIG. 15, a local vs. non-local expense graph 350 includes a non-trip or local spending distribution curve 352 for local employees of a company and a trip or non-local spending curve 354 for non-local employees of the company. Additionally, FIG. 15 includes a first indicator, shown as dashed line 356, that indicates the average spending per local expense, and a second indicator, shown as dashed line 358, that indicates the average spending per non-local expense. The local average spending indicated by the dashed line 356 may be compared to average non-local spending indicated by the dashed line 358 to assess the anticipated cost savings per transaction and estimate anticipated financial impact of improved employee buying behavior as described in further detail herein.

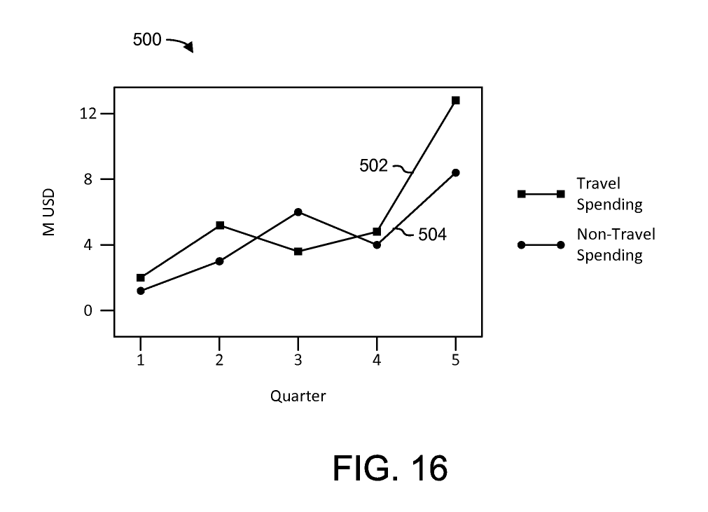

Referring to FIGS. 1 and 16, the benchmarking module 30 may be configured to analyze the T&E data to provide T&E spending patterns over time. As shown in FIG. 16, a T&E spending graph 500 may be provided by the benchmarking module 30 to indicate T&E spending patterns over time. The T&E spending graph 500 includes a travel spending curve 502 indicating travel spending patterns over time (e.g., period-to-period, quarterly, monthly, weekly, etc.). The T&E spending graph 500 also includes a non-travel spending curve 504 indicating non-travel spending patterns over time (e.g., period-to-period, quarterly, monthly, weekly, etc.). In some embodiments, the T&E spending graph 500 includes additional curves such as sales curves, production curves, and the like to compare to the travel spending curve 502 and/or the non-travel spending curve 504 over time. The T&E spending graph 500 may be generated on a person-by-person basis, a business unit basis, a company wide basis, or the like.

According to an exemplary embodiment, the T&E spending graph 500 provides a user of the T&E analysis system 10 with the ability to monitor whether T&E spending aligns with business unit and/or company objectives. For example, a company may be pushing for global expansion, and therefore, may increase travel spending to reach new clients and/or build or acquire facilities in new locations. Thus, the benchmarking module 30 may be configured to use the T&E spending graph 500 to compare sales with travel spending indicated by the travel spending curve 502. If the increase in travel spending does not actually cause an increase in sales, a company may react accordingly. As another example, the benchmarking module 30 may be configured to compare the travel spending curve 502 to a travel spending threshold and/or compare the non-travel spending curve 504 to a non-travel spending threshold. If the travel spending and/or the non-travel spending exceed the respective thresholds, the benchmarking module 30 may be configured to provide an alert regarding such an occurrence so that a user may identify the cause(s) behind the unwanted increase (as explained above in relation to the trip module 24 and the non-trip module 26). In yet another example, the benchmarking module 30 may be configured to compare the travel spending curve 502 to the non-travel spending curve 504. The difference between the two may be compared to a difference threshold and a corresponding alert may be generated by the benchmarking module 30 if the difference exceeds the difference threshold. In still another example, the benchmarking module 30 may be configured to analyze the fluctuations in the travel spending curve 502 and/or the non-travel spending curve 504. For example, the benchmarking module 30 may be configured to analyze the rate of change of T&E spending over time (e.g., monthly, weekly, quarterly, etc.). The benchmarking module 30 may be configured to provide an alert if the rate of change in spending from one period to the next is outside of a fluctuation range (e.g., plus or minus 10%, 25%, 50%, etc. of the previous period). This may provide users with the ability to address fluctuations in spending behavior before it may become problematic.

The display module 32 is configured to provide a display on the user I/O device 50 (e.g., a monitor, a touchscreen, a display screen, etc.). The display module 32 is further configured to provide the display regarding various user interfaces (e.g., a projection interface, a benchmarking interface, an overall results analysis interface, etc.) corresponding with the T&E analysis system 10. The display module 32 may also be configured to display various other features and/or user interfaces not related to the present disclosure. The display module 32 may also be configured to receive an input from a user of the T&E analysis system 10 via the user I/O device 50 (e.g., touchscreen inputs, button inputs, etc.). The input may include a command to instruct the display module 32 which user interface to display to the user of the T&E analysis system 10 based on the inputs. The display module 32 may also be configured to receive a command from the T&E analysis module 22 to display certain user interfaces to a user of the T&E analysis system 10. For example, the T&E analysis module 22 may send T&E data, projection data, and/or benchmarking data to the display module 32 regarding a request provided by the user.

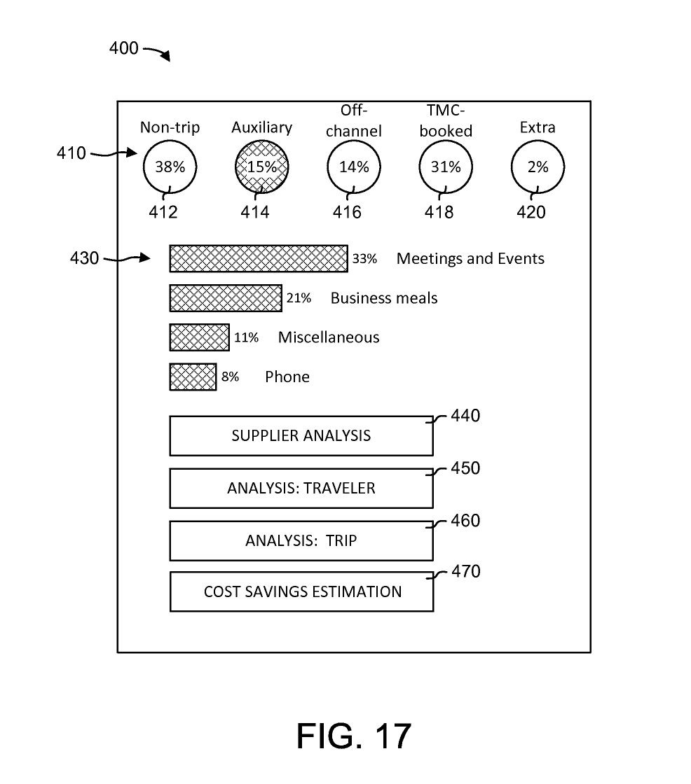

According to the exemplary embodiment shown in FIG. 17, a graphical user interface, shown as T&E results interface 400, may be provided to a user of the T&E analysis system 10 on the user I/O device 50. As shown in FIG. 17, the T&E results interface 400 includes a graphical display including categories of T&E spending 410 including non-trip expenses 412, auxiliary expenses 414, off-channel expenses 416, TMC booked expenses 418, and extra expenses 420. According to an exemplary embodiment, the T&E results interface 400 facilitates a user selecting one of the categories of T&E spending 410 to see a more detailed display, shown as subcategory display 430. The subcategory display 430 provides a user with a more detailed view of the selected category of T&E spending 410. In some embodiments, a user is able to select one of the subcategories of the subcategory display 430 to see a more detailed display of the individual subcategory (e.g., cost per person, cost to date for the subcategory, most frequented vendors/suppliers for the subcategory, etc.).

As shown in FIG. 17, the T&E results interface 400 further includes a supplier analysis button 440, a traveler analysis button 450, a trip analysis button 460, and a cost savings estimation button 470. The supplier analysis button 440 may be selected to analyze expenses for certain suppliers. This may facilitate a user in decreasing costs with frequently used suppliers by negotiating contracts or package deals for frequently used services. The traveler analysis button 450 may be selected to analyze a specific employee's spending behavior and/or benchmark the employee's spending relative to other employees (see, e.g., FIG. 14). The traveler analysis button 450 may provide an indication to an employee's compliance with company standards and regulations, as well as frequency of booking off-channel. In some embodiments, the T&E analysis system 10 automatically emails alerts to a company (e.g., management, compliance officers, etc.) or provides an indication on the T&E results interface 400 regarding non-compliant employee spending. The trip analysis button 460 may be selected to analyze a specific employee's spending behavior over a trip and/or benchmark the employee's trip relative to similar trips (see, e.g., FIG. 14). The trip analysis button 460 may also be selected to project a potential cost of a trip based on inputted trip parameters and prior trips that match the trip parameters (see, e.g., FIG. 13).

The cost savings estimation button 470 may be selected to analyze the financial impact of actions that may be taken both on the supply side and the demand side. By way of example, on the supplier side, such actions may include (i) consolidating current suppliers to improve negotiating power (e.g., directing travelers to fly primarily with Air France on a Paris to New York route and getting lower ticket price from Air France in return, use knowledge of frequently used/purchased ancillary services to increase leverage and arrange packaged solutions during future supplier negotiations, etc.) and/or (ii) introducing a new partnering agreement with a service or product provider (e.g., a corporate discount with a major restaurant chain, etc.). By way of another example, on the demand side, such actions may include (i) identifying outliers as described above in relation to FIG. 14 and educating such outliers to adhere to practices followed by the majority of their peers, (ii) identifying off-channel booking patterns and using the patterns to direct employees to use policy-compliant booking tools as described above, (iii) and/or comparing buying habits of local and non-local employees and educating non-local employee to improve their overall experience, as well as receive better quality for a lower price (e.g., by avoiding tourist traps, by partaking in the local culture, etc.).

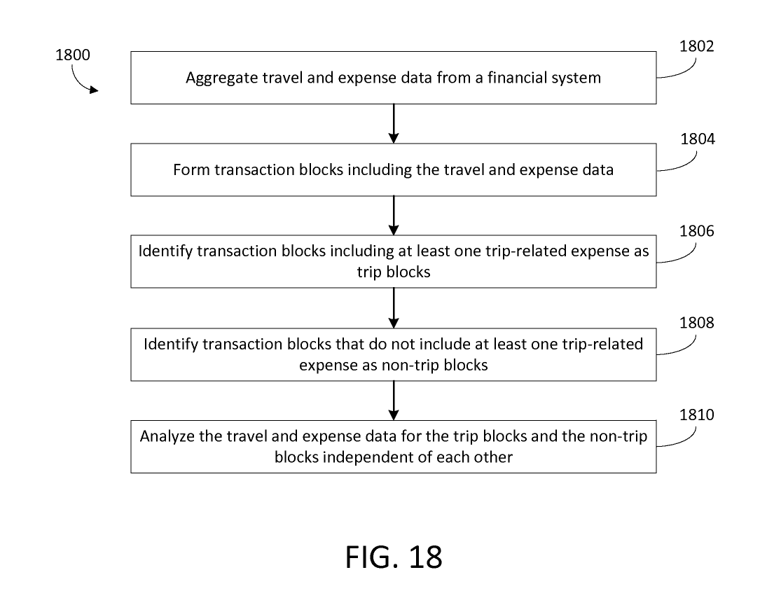

Referring now to FIG. 18, a method 1800 for analyzing travel and expense spending is shown according to an exemplary embodiment. In one example embodiment, method 1800 may be implemented with the T&E analysis system 10 of FIG. 1. Accordingly, method 1800 may be described in regard to FIG. 1.

At step 1802, the T&E analysis system 10 is configured to aggregate T&E data (e.g., indicative of employee spending, expenses, transactions, etc.) from a financial system (e.g., the financial system 40, etc.). The financial system may be or include a system that is configured to receive and store T&E data (e.g., transaction information, etc.) indicative of T&E spending (e.g., for an employee, for a company, etc.). According to an exemplary embodiment, the financial system includes at least one of an expense reporting system, a financial accounting system, and a credit card system (e.g., including personal credit card statements, corporate credit card statements, etc.). At step 1804, the T&E analysis system 10 is configured to form transaction blocks including the T&E data. The transaction blocks may include expenses that at least one of have a similar trip or expense identifier, occurred on a similar date or within a similar date range, and have at least one similarly involved employee.

At step 1806, the T&E analysis system 10 is configured to identify transaction blocks including at least one expense related to air travel, lodging, and/or rental car transactions (e.g., trip-related expenses, etc.) as trip blocks. At step 1808, the T&E analysis system 10 is configured to identify transaction blocks that do not include expenses related to air travel, lodging, and/or rental car transactions (e.g., non-trip-related expenses, etc.) as non-trip blocks. In some embodiments, the T&E analysis system 10 omits step 1804 and identifies each individual expense as a trip expense or a non-trip expense. At step 1810, the T&E analysis system 10 is configured to analyze the T&E data for the trip blocks (or trip-related expenses) and the non-trip blocks (or non-trip-related expenses) independent of each other.

Analyzing the trip blocks (or trip-related expenses) may include categorizing each, individual trip-related expense into subcategories. According to an exemplary embodiment, the subcategories include auxiliary trip expenses (e.g., auxiliary expenses 130, etc.), off-channel air, hotel, and car expenses (e.g., off-channel expenses 150, etc.), travel management company booked in-channel air, hotel, and car expenses (e.g., TMC booked expenses 160, etc.), and/or extra in-channel air, hotel, and car expenses (e.g., extra expenses 170, etc.). In some embodiments, the subcategories of the trip expenses are further subcategorized into specific types of expenses (e.g., meals, air, hotel, car, transportation, etc.). Analyzing the trip blocks may also include benchmarking a trip block and/or an individual trip-related expense relative to prior, similar trip blocks and/or trip-related expenses (e.g., to find a quality value of the trip and/or expense, etc.). In some embodiments, the T&E analysis system 10 is configured to facilitate projecting costs of trips and/or trip-related expenses based on similar trip blocks and/or trip expenses. In some embodiments, the T&E analysis system 10 is configured to provide an analysis of T&E spending (e.g., travel spending, non-travel spending, etc.) over time.

Analyzing the non-trip blocks (or non-trip-related expenses) may include categorizing each, individual non-trip-related expense into subcategories (e.g., meals, transportation, phone plane, office supplies, etc.). Analyzing the non-trip blocks may also include benchmarking a non-trip block and/or an individual non-trip-related expense relative to prior, similar non-trip blocks and/or non-trip-related expenses (e.g., to find a quality value of no-trip-related expense(s), etc.).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for integrating travel and expense data, comprising:
a communications interface configured to facilitate receiving travel and expense data in disparate formats; and
a processing circuit coupled to the communications interface, the processing circuit configured to:
receive first travel and expense data in a first format;
receive second travel and expense data in a different, second format, wherein the first travel and expense data and the second travel and expense data are received from one or more financial systems and include a plurality of expense transactions;
remove erroneous portions of at least one of the first travel and expense data or the second travel and expense data;
apply a matching algorithm to the first travel and expense data and the second travel and expense data to generate a similarity score to identify that the first travel and expense data and the second travel and expense data are related;
identify each of the plurality of expense transactions of the first travel and expense data and the second travel and expense data as trip-related expenses or non-trip-related expenses; and
analyze the trip-related expenses and the non-trip-related expenses independent of each other.

2. The system of claim 1, wherein the one or more financial systems include at least one of an expense reporting system, a financial accounting system, or a credit card system.

3. The system of claim 1, wherein the trip-related expenses are related to at least one of air travel expenses, lodging expenses, or rental car expenses.

4. The system of claim 1, wherein analyzing the trip-related expenses and the non-trip-related expenses includes categorizing each of the trip-related expenses and the non-trip-related expenses into subcategories based on a decision tree framework.

5. The system of claim 4, wherein the decision tree framework is configured to establish whether a transaction (i) was made while travelling, (ii) is associated with an airline company, a hotel, or a car rental company, (iii) was made via a travel management company, and (iv) has a different amount than an amount recorded when booked by the travel management company.

6. The system of claim 4, wherein the subcategories of the trip-related expenses include auxiliary trip expenses, off-channel expenses, travel management company booked expenses, or extra expenses.

7. The system of claim 6, wherein the auxiliary trip expenses relate to expenses that are not booked through a travel management company and do not relate to at least one of an airline company, a hotel, or a car rental company.

8. The system of claim 6, wherein the off-channel expenses relate to expenses that were booked by a traveler directly and relate to at least one an airline company, a hotel, or a car rental company.

9. The system of claim 6, wherein the travel management company booked expenses relate to expenses booked by a travel management company.

10. The system of claim 6, wherein the extra expenses relate to expenses that are added to a travel management company booked service by a traveler.

11. The system of claim 6, wherein the processing circuit is configured to provide a graphical user interface of an analysis of the trip-related expenses and the non-trip-related expenses on a display device.

12. The system of claim 11, wherein at least one of (i) the analysis of the trip-related expenses and the non-trip-related expenses, including the subcategories, are simultaneously displayed or (ii) the analysis facilitates evaluating a financial impact of actions taken on both a supply side and a demand side of travel and expense spending.

13. The system of claim 1, wherein analyzing the trip-related expenses and the non-trip-related expenses includes benchmarking a trip-related expense or a non-trip-related expense relative to similar trip-related expenses or similar non-trip-related expenses, respectively, and wherein the processing circuit is configured to identify a quality of the trip-related expense or the non-trip-related expense relative to the similar trip-related expenses or the similar non-trip-related expenses, respectively.

14. The system of claim 1, wherein analyzing the trip-related expenses and the non-trip-related expenses includes identifying outlier transactions.

15. The system of claim 1, wherein the processing circuit is configured to project a total cost of a trip based on inputted trip parameters and the travel and expense data.

16. The system of claim 1, wherein the processing circuit is configured to monitor the travel and expense data over time.

17. The system of claim 1, wherein the processing circuit is configured to determine that the first travel and expense data and the second travel and expense data relates to at least one of a same employee or a same trip in response to the similarity score being greater than a threshold value.

18. The system of claim 1, wherein the processing circuit is further configured to compare similar trip-related expenses and non-trip-related expenses for non-local employees and local employees to facilitate analyzing buying behavior of the non-local employees relative to the local employees for similar expenses.

19. A method for integrating travel and expense data, comprising:
receiving, by a processing circuit, first travel and expense data in a first format from a first financial system;
receiving, by the processing circuit, second travel and expense data in a different, second format from a second financial system, wherein the first travel and expense data and the second travel and expense data include a plurality of expense transactions;
applying, by the processing circuit, a matching algorithm to the first travel and expense data and the second travel and expense data to generate a similarity score to identify that the first travel and expense data and the second travel and expense data are related;
identifying, by the processing circuit, each of the plurality of expense transactions of the first travel and expense data and the second travel and expense data as trip-related expenses or non-trip-related expenses; and
analyzing, by the processing circuit, the trip-related expenses and the non-trip-related expenses independent of each other.

20. A system for integrating travel and expense data, comprising:
a communications interface configured to receive travel and expense data from one or more financial systems in disparate formats, wherein the travel and expense data includes a plurality of expense transactions; and
a processing circuit configured to:
apply a matching algorithm to the disparate formats of the travel and expense data to generate a similarity score to identify related transactions from the plurality of expense transactions;
identify each of the related transactions of the plurality of expense transactions of as trip-related expenses or non-trip-related expenses; and
analyze the trip-related expenses and the non-trip-related expenses independent of each other;
wherein the related transactions are associated with at least one of a same employee or a same trip.
